(19) United States
(12) Patent Application Publication
(10) Pub. No.: US 2026/0165329 A1
(43) Pub. Date: Jun. 18, 2026

(54) AIR IMPINGING DUCT WITH ADJUSTIBLE HOUSING VENT

(71) Applicant: LINCOLN FOODSERVICE EQUIPMENT, LLC, Fort Wayne, IN (US)

(72) Inventors: Lucian Lordache, Woodbridge (CA); Nicko Hoang, Hamilto (CA); Alexander Nahhas, Toronto (CA)

(73) Assignee: LINCOLN FOODSERVICE EQUIPMENT, LLC, Fort Wayne, IN (US)

(21) Appl. No.: 19/382,749

(22) Filed: Nov. 7, 2025

Related U.S. Application Data
(60) Provisional application No. 63/723,375, filed on Nov. 21, 2024.

(51) Int. Cl. A21B 1/24; A21B 1/26

(52) U.S. Cl. CPC A21B 1/245; A21B 1/26

(57) ABSTRACT

An impinging air duct and a conveyor oven that employs the duct. A conveyor moves a food product through the oven, where heated air is passed through the ducts and onto the food to cook it. One or more ducts can be above and/or below the conveyor. The duct has a housing with a jet plate connected thereto, with orifices in the jet plate. The housing has one or more apertures thereon, and a moveable shutter connected to the housing. The shutter can be adjusted to completely cover the apertures on the housing, completely expose the apertures on the housing, or any amount in between. When the shutter at least partially exposes the housing aperture, the pressure in the duct will drop, but still remain uniform. The pressure at any point in the duct can be within 10%, more preferably 5%, or the average pressure across the entire duct.

### CROSS-REFERENCE TO RELATED APPLICATION

The present application claims the benefit under 35 U.S.C. § 119 of U.S. Provisional Patent Application Ser. No. 63/723,375, filed on Nov. 21, 2024, which is herein incorporated by reference.

### BACKGROUND OF THE DISCLOSURE

### 1. Field of the Disclosure

The present disclosure relates to impinging air ducts that are used in industrial ovens. More particularly, the present disclosure relates to air impinging air ducts having an adjustable opening or vent on the housing that allows for customization of the air pressure within the duct.

### 2. Discussion of the Related Art

In industrial food-making operations, a conveyor belt oven is often used to cook food items such as pizzas, sandwiches, vegetables, and others. A food item is placed on a conveyor belt that passes through an inlet of a chamber and out the other end of the chamber, by which time it is cooked or heated. The inside of the chamber is heated. Typically, one or more impinging air ducts above and/or below the conveyor will blow heated and pressurized air through orifices in a jet plate onto the food item as it passes by the ducts, to cook or heat the food. As each food item will require different cooking times and other parameters, there is a continuing need to make conveyor ovens more efficient and easier to adjust depending on the food that is to be cooked.

Previously, one way the skilled artisans in the field sought to control the amount of air and energy being delivered to the food product was by obstructing the orifices in the jet plate. This led to a backlash flow in the duct, producing turbulent flow in the duct and plenum. Another way was to swap out different ducts or jet plates for different food items or use multiple fans in the oven. These are costly modifications both in the additional materials needed and the time and labor they require. The present disclosure eliminates these and other disadvantages.

### SUMMARY OF THE DISCLOSURE

The present disclosure provides an air impingement duct, otherwise known as a “finger duct” or a “finger assembly”. The air impingement duct comprises a housing and at least one jet plate. The housing is a shell having a u-shaped cross-section with three sides, namely a base and two side walls. The housing has an opening at a first end, i.e. a plenum end, through which the duct receives heated and pressurized air from a source (such as a plenum with a blower or fan). The housing further has a closed end wall at a distal end thereof, which is on an opposite end of the housing from the plenum end. The jet plate is connected to the two side walls and the closed end wall, so that an interior space is defined by the housing and the jet plate. The jet plate has a plurality of orifices thereon. Heated and pressurized air passes from the opening at the plenum end of the housing, along the length of the housing toward the closed end wall, and out of the orifices of the jet plate, where it contacts and cooks or heats a food item.

Advantageously, the base of the housing has one or more adjustable openings disposed thereon. Because of this, when the air impingement ducts of the present disclosure are used in conveyor ovens, the operator of that oven has significant flexibility in how the food is cooked.

The air impingement duct is positioned either above or below the food conveyor, and in either arrangement the jet plate is between the base of the housing and the conveyor. When the air impingement duct is above the food conveyor, the base with the adjustable openings therein is above the jet plate, i.e. the jet plate is between the base of the housing and the conveyor. When the air impingement duct is below the conveyor, the base with the adjustable openings is below the jet plate, i.e. that the jet plate is again between the base of the housing and the conveyor.

As discussed in greater detail below, it was previously thought undesirable to have holes in the housing of an air impingement duct, as that air would be lost and not drawn back into the plenum for redistribution in cooking of the food disposed on the conveyor. The present disclosure addresses these disadvantages as well.

Accordingly, in one embodiment, the present disclosure provides an air impingement duct, comprising: a jet plate having a plurality of orifices thereon; a housing, wherein the jet plate is connected to the housing, so that an interior space is defined by the housing and the jet plate; a housing aperture in a base of the housing, wherein the base is opposite the jet plate; and a shutter that is movably connected to the side of the housing with the housing aperture. The movement of the shutter selectively covers and uncovers at least a portion of the housing aperture.

The present disclosure also provides a conveyor oven, comprising: an oven housing; a conveyor; an entrance and an exit, wherein the conveyor passes through the entrance, exit, and oven housing, to convey a food product therethrough; a plenum within the housing, wherein heated air is circulated within the plenum; and the duct of the preceding paragraph. The duct is disposed above or below the conveyor. Heated air passes from the plenum into the duct, and out of the duct onto the food product.

The present disclosure also provides a method of operating a conveyor oven, wherein the conveyor oven comprises: an oven housing; a conveyor, wherein the conveyor passes through the oven housing, to convey a food product therethrough; a plenum within the housing; and the above-described duct. The method comprises the steps of: passing heated air from the plenum into the duct of and out of the duct of the preceding paragraph onto the food product; and adjusting the shutter to adjust a pressure of the heated air within the duct. The duct can have an average air pressure therein, and the air pressure at any point within the duct of claim can be within 10% of the average air pressure.

### BRIEF DESCRIPTION OF THE DRAWINGS

FIG. 1 is a perspective view of an impinging air duct of the present disclosure.

FIG. 2 is a top view of the duct of FIG. 1.

FIG. 3 is a view of the air shutter and apertures of the duct of FIG. 1, with the shutter in a closed state.

FIG. 4 is a view of the air shutter and apertures of the duct of FIG. 1, with the shutter in an open state.

FIG. 5 is a view of the air shutter of the duct of FIG. 1.

FIG. 6 is a second perspective view of the duct of FIG. 1, with the jet plate removed.

FIG. 6a is a cross-sectional view of the duct of FIG. 6, along line 6a-6a.

FIG. 6b is a side view of the duct of FIG. 6.

FIGS. 7a, 7b, 7c, and 7d show a view of the air shutter and apertures of the duct of FIG. 1, in varying positions.

FIG. 8 is a top transparent perspective view of a conveyor oven utilizing the duct of FIG. 1.

FIG. 9 is a bottom transparent perspective view of the conveyor oven of FIG. 8.

FIG. 10 is a cross-sectional view of the oven of FIG. 8 that also shows a schematic of air flow within the oven.

FIGS. 11A, 11B, 12A, 12B, 13A, 13B, 14A, and 14B plots for air pressures at several points on the air duct, and with the shutter at varying positions, as well as the change in overall pressure within the duct as a function of the size of the vent opening.

FIG. 14C is a graph showing some of the data of FIGS. 11A-14B and Table 1 of the present disclosure.

FIG. 15 shows a schematic of a simulated air flow in the air duct of the present disclosure.

FIG. 16 shows a perspective view of a second embodiment of an impinging air duct of the present disclosure.

FIG. 17 shows a second perspective view of the duct of FIG. 16, with a transparent shutter cover.

FIG. 18 shows a top view of the duct of FIG. 17.

FIG. 19 is a top transparent perspective view of a conveyor oven utilizing the duct of FIG. 16.

FIG. 20 is a cross-sectional view of the oven of FIG. 19 that also shows a schematic of air flow within the oven.

FIG. 21 shows a perspective view of a third embodiment of an impinging air duct of the present disclosure, with the shutter in a closed position.

FIG. 22 shows a perspective view of the duct of FIG. 21, with the shutter in an open position.

FIG. 23 shows a top view of the duct of FIG. 21, with the shutter in a closed position.

FIG. 24 shows a top view of the duct of FIG. 21, with the shutter in an open position.

FIG. 25 is a top transparent perspective view of a conveyor oven utilizing the duct of FIG. 21.

FIG. 26 is a cross-sectional view of the oven of FIG. 25 that also shows a schematic of air flow within the oven.

### DETAILED DESCRIPTION OF THE DISCLOSURE

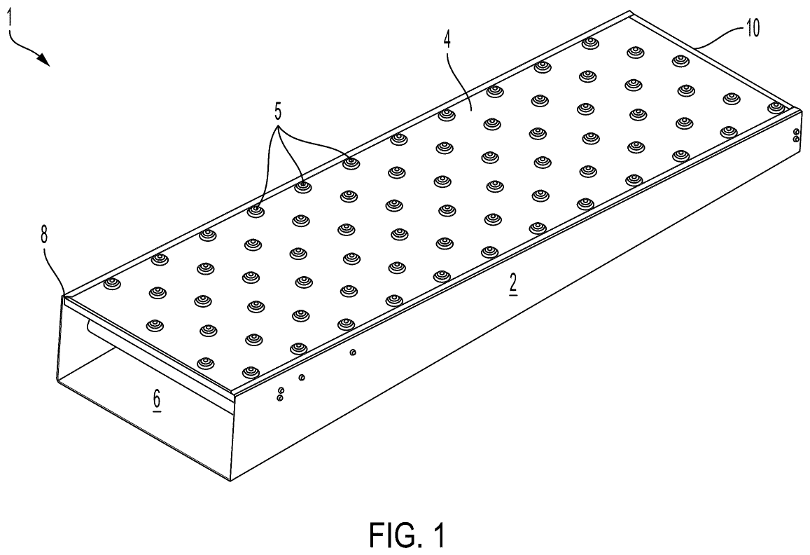

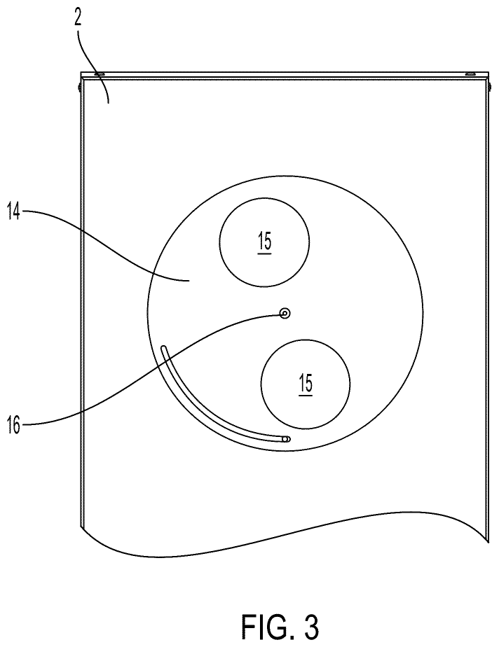

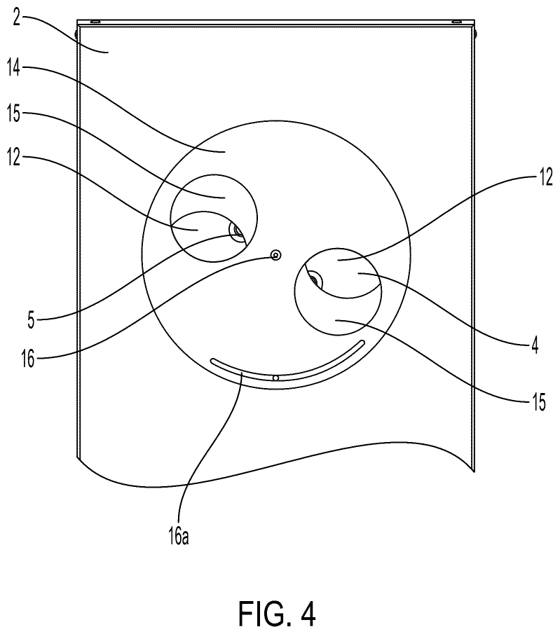

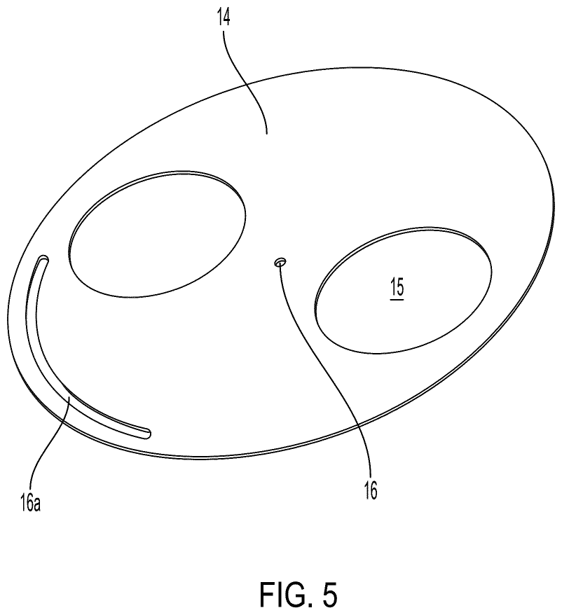

Referring to the drawings, and in particular FIGS. 1-6, air impinging duct 1 of the present disclosure is shown. Duct 1 has a housing 2, jet plate 4, and an opening 6. Duct 1 also has a back or plenum end 8 (where opening 6 is located), and a front or door end 10. Jet plate 4 has a plurality of orifices 5 thereon. Duct 1 is placed in an oven having a conveyor passing therethrough. Duct 1 can be placed above or below the conveyor. As described in greater detail below, heated and pressurized air is supplied to duct 1 through opening 6. This air circulates throughout housing 2, and passes through orifices 5, to heat a food product on the conveyor.

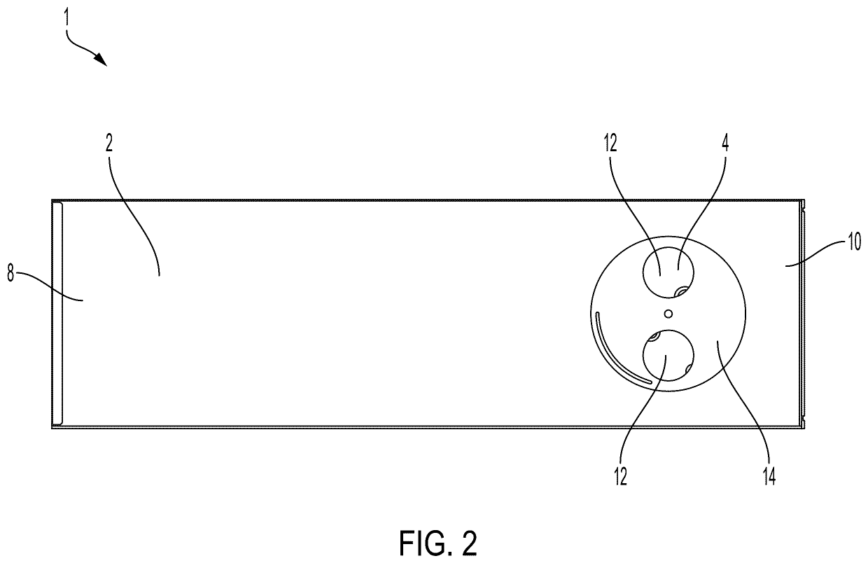

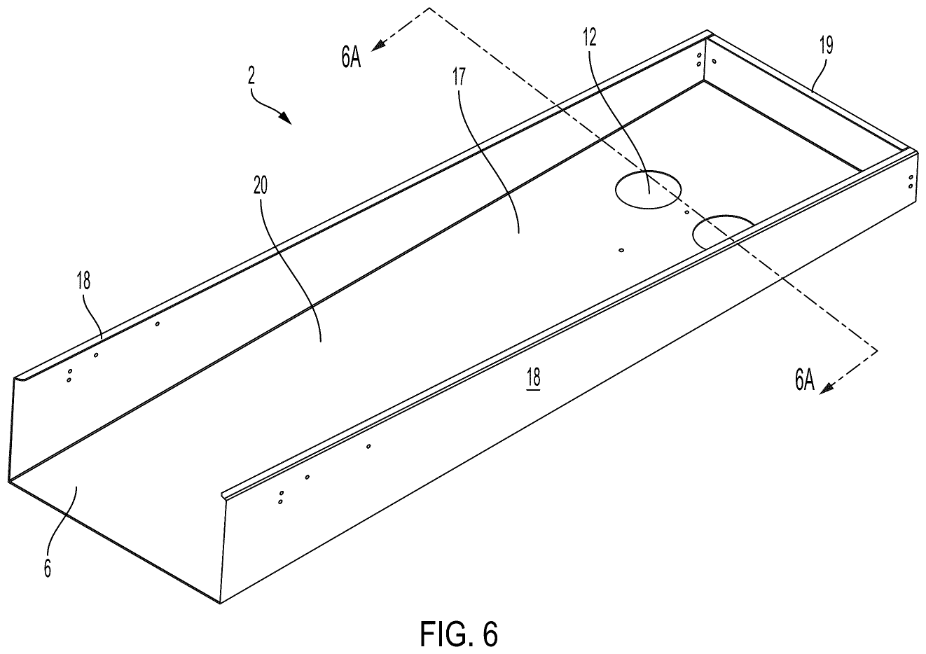

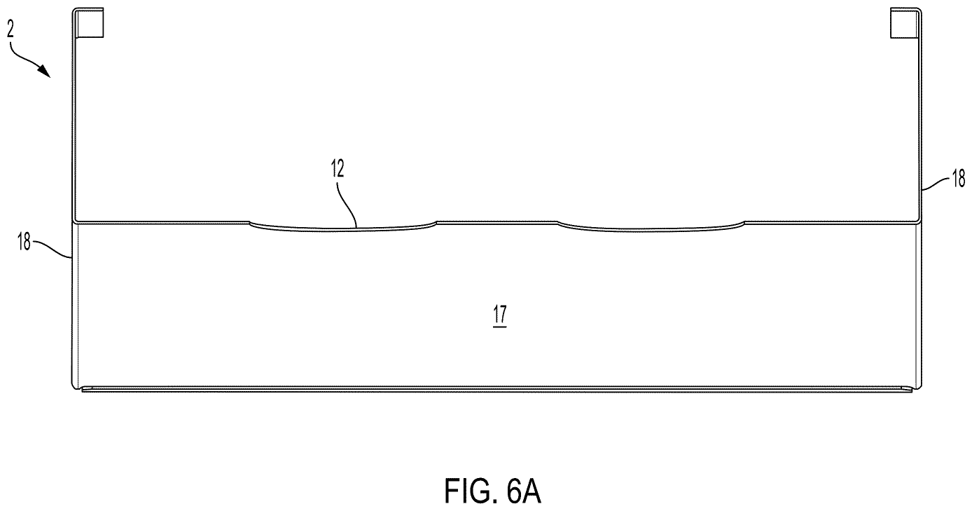

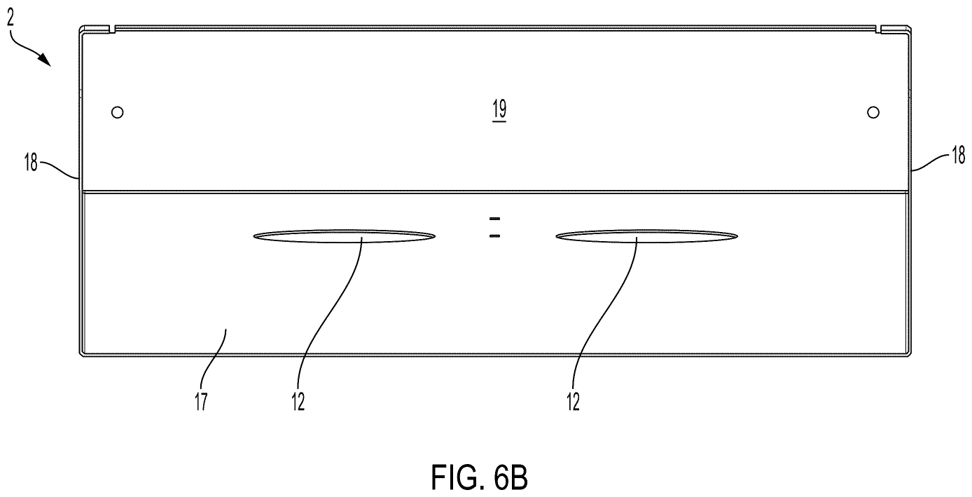

As seen FIG. 2 and FIG. 6 in particular, housing 2 has one or more housing apertures 12 therein, closer to front end 10 than back end 8. A shutter 14 is connected to housing 2 so that it can selectively cover and uncover housing apertures 12. Shutter 14 can completely cover housing apertures 12, i.e., 100% coverage, completely uncover housing apertures 12, i.e., 0% coverage, or any amount or subranges therebetween. Shutter 14 can be easily adjusted manually or via a control system.

Accordingly, duct 1 presents significant advantages not found in current impingement air ducts and conveyor ovens. In current conveyor ovens, the air pressure within the duct cannot be adjusted in situ, and the impinging air ducts have to be switched out depending on the food product that is to be cooked. This is labor intensive and time-consuming. Other solutions include having multiple air circulation systems and fans within the same oven, but this adds to the cost and complexity of the oven. With duct 1 of the present disclosure, a simple adjustment of shutter 14 can significantly affect the amount of pressure at which heated air is delivered to the food product, without costly or inconvenient oven modifications.

Other ovens have attempted to change the air flow to the food product by obstructing or adjusting the size and orientation of orifices on the jet plate. As described above, this still requires the swapping out of equipment for different food cooking parameters. The inventors of the present disclosure also discovered that obstructing jet orifices can lead to backlash and turbulent flow in the duct, which is undesirable. Another consideration is that for efficiency purposes, in air impingement ovens it is desirable that the air that is directed to the food product circulates back to the plenum. It was previously thought undesirable to have apertures in the housing of the duct, since air would exit through those apertures and not enter the recirculation flow, resulting in heat loss. However, as discussed in greater detail below, the present inventors discovered that the tradeoff in heat loss and convenience was advantageous, and also discovered ways to minimize the loss.

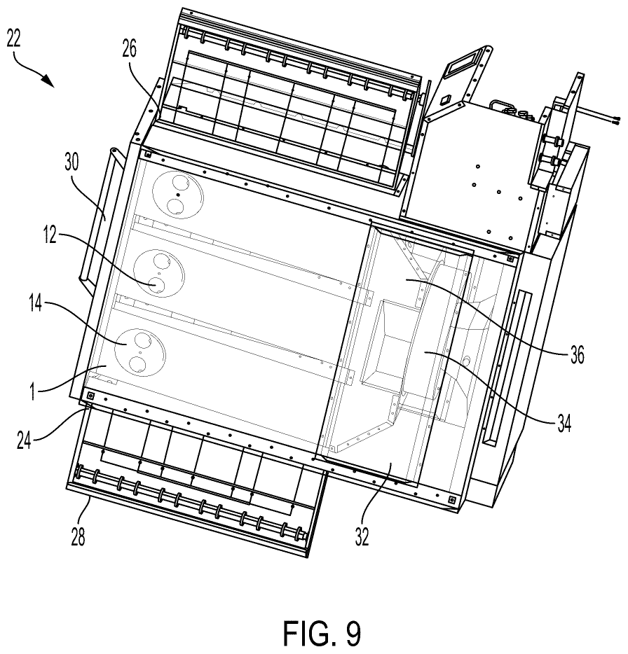

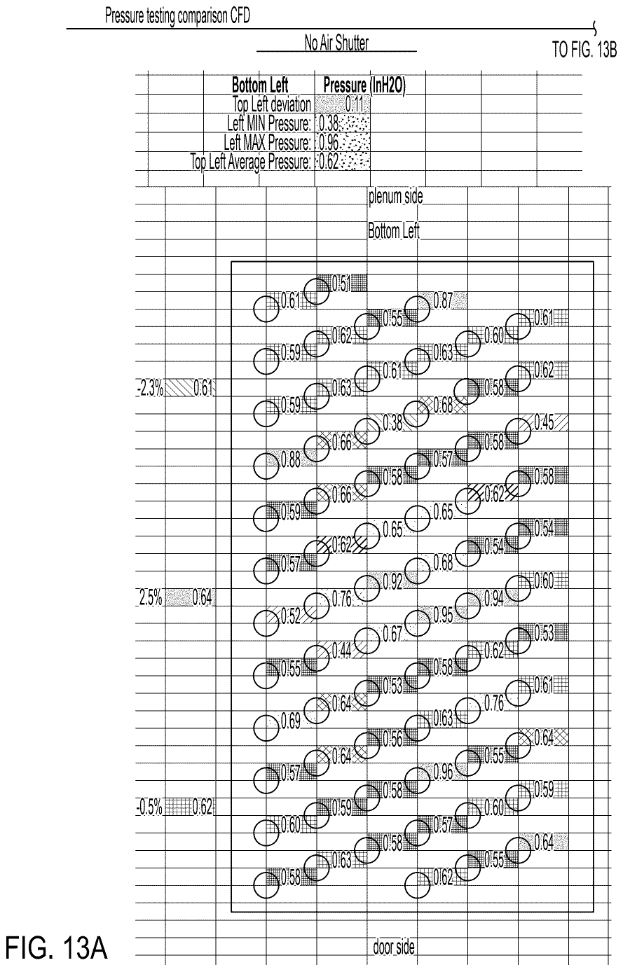

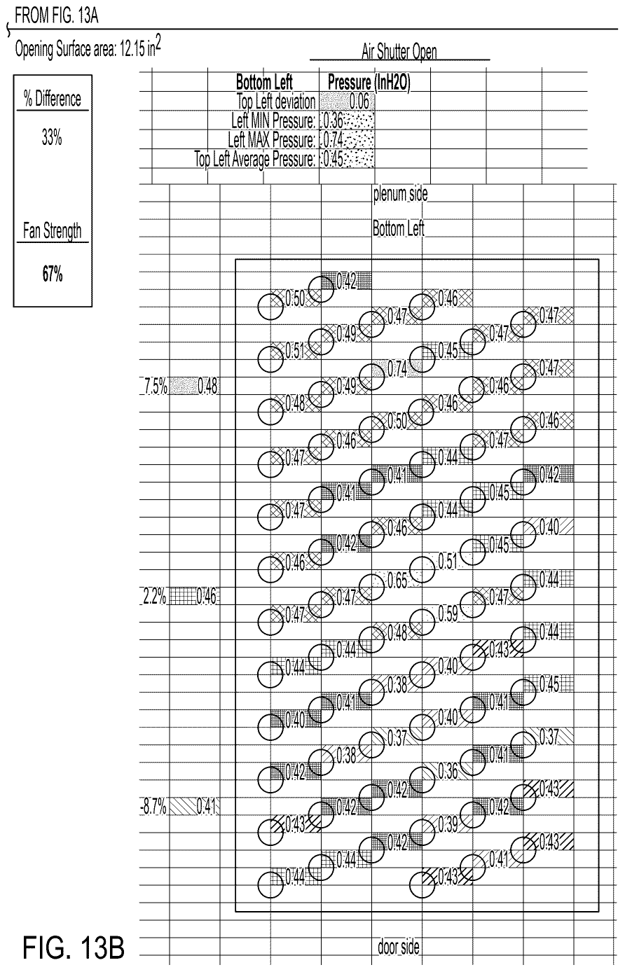

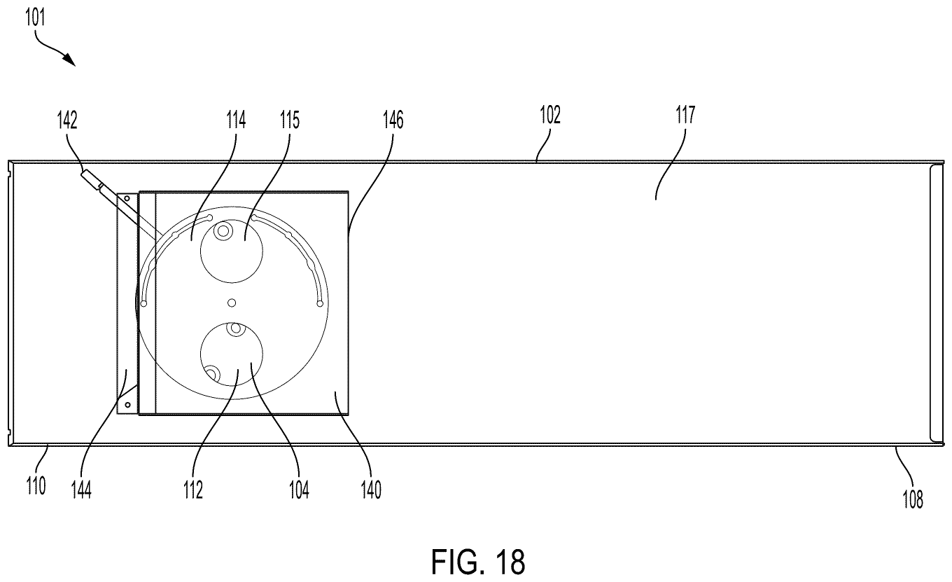

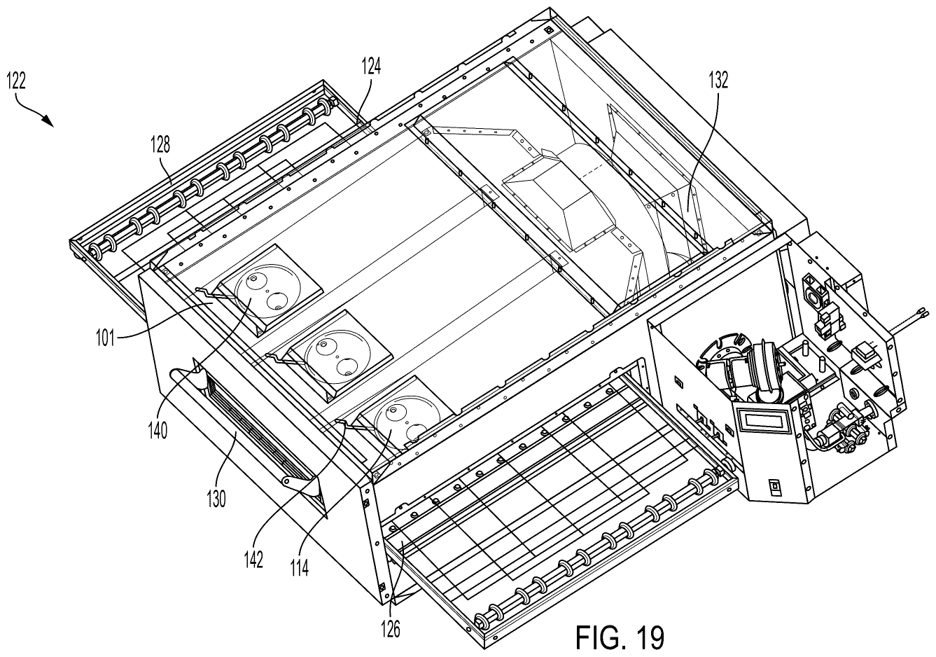

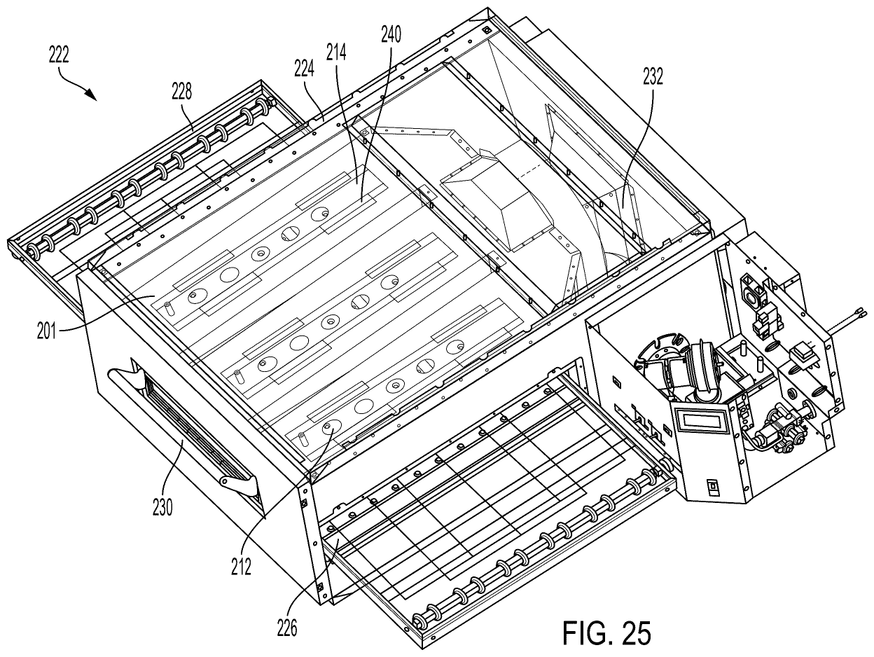

In the shown embodiments, housing apertures 12 are circular. However, other shapes such as squares, ellipses, rectangles, and triangles are contemplated by the present disclosure. Further, in the embodiments of FIGS. 1-20, there are two housing apertures 12. However, the present disclosure contemplates one or more housing apertures 12 in housing 2, including two or more or three or more. As described below, the embodiment of FIGS. 21-26 has five apertures. One advantage to having one large housing aperture 12 is that the air exiting a comparatively large aperture will move more slowly than in smaller housing apertures 12, so it might be easier for air exiting a single housing aperture 12 to join the air pathway returning to the plenum.

As discussed in greater detail below, the present inventors have unexpectedly discovered that even when housing apertures 12 are open to a substantial extent, thus reducing the pressure of the air that exit orifices 5, there is not a significant drop off in pressure uniformity along duct 1. This is highly advantageous, since conveyor ovens that operate at lower pressures are more efficient, as less heat will escape the oven. The air velocity has an effect on the value of heat transfer coefficient between the heated air and the food product. The faster the air, the higher the coefficient, and the higher the amount of heat transfer. At lower pressures, less overall energy is delivered to the food product. The total exposed area of housing apertures 12 can range from 6.075 square inches to 16.2 square inches, or any subranges therebetween.

In the embodiments of FIGS. 1-20, housing apertures 12 are closer to front end 10, meaning that if duct 1 has a midpoint along its length, apertures 12 are on a side of that midpoint that is closer to front end 10. This location can be advantageous in that it allows the pressurized air entering opening 6 to reach most or all of orifices 5 in jet plate 4 before exiting duct 1 through housing apertures 12. The air flow within duct 1 also tends to be less turbulent near front end 10. The present disclosure contemplates that housing apertures 12 can be in other areas of housing 2, for example as in the embodiment of FIGS. 21-26.

In the shown embodiments, shutter 14 is a circular metal disk that has two shutter apertures 15 thereon, which can align with housing apertures 12. Circular shapes can be advantageous for housing apertures 12 and shutter apertures 15, as circles have no sharp edges or corners that can be a source of friction for air passing therethrough. As discussed above, other shapes are also contemplated. Shutter 14 can rotate about a center 16 that is connected to housing 2. Shutter 14 can also have a notch 16a cut therein which can be used to lock shutter 14 in place as needed, for example during a cleaning process.

FIG. 6a shows a cross-section of housing 2, along line 6a-6a of FIG. 6. FIG. 6b is a view of housing 2 looking from opening 6 at plenum end 8 to door end 10. As can be seen in FIGS. 6a and 6b in particular, housing 2 has a u-shaped cross-section, with a longer side or base 17 that is opposite jet plate 4, two shorter side walls 18 that project from base 17, and an end leg 19 that also projects from base 17. Base 17, side walls 18, and end leg 19 together form a shell that defines an interior space 20. Jet plate 4 is connected to side walls 18 and end leg 19 so that in use, heated air enters duct through opening 6, circulates through interior space 20, and out through orifices 5 in jet plate 4 toward the food product. Housing apertures 12 are in base 17, i.e. not in side walls 18, the latter of which are adjacent to and contact jet plate 4. The length of side walls 18 tapers off from plenum end 8 to door end 10, so that duct 1 has a wedge-shaped profile. The present disclosure contemplates other shapes for duct 1 and housing 2, provided that apertures 12 are in a side of housing 2 that is opposite to, and not adjacent to, jet plate 4.

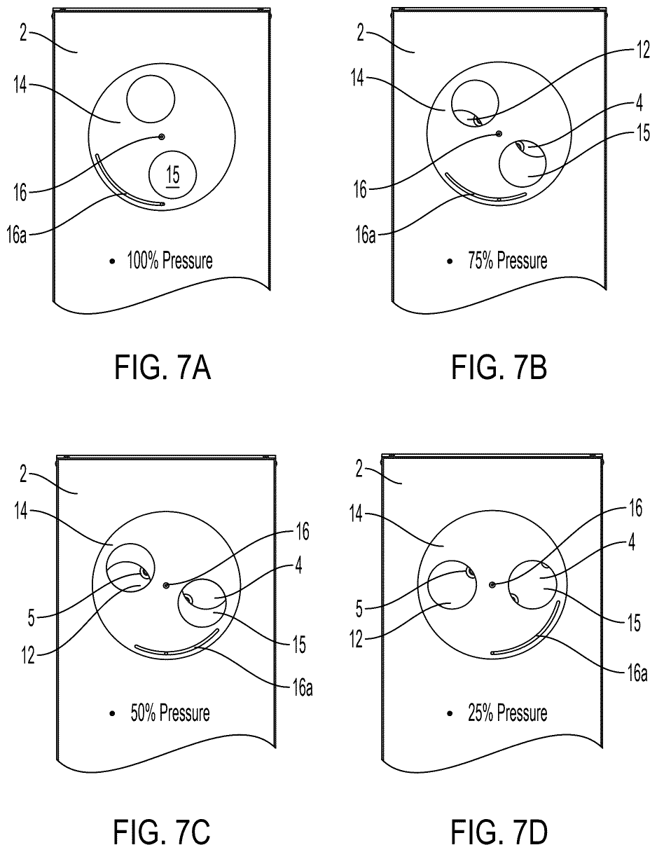

Referring to FIGS. 7a, 7b, 7c, and 7d, a top view of duct 1 is seen where housing apertures 12 are in varying states of coverage by shutter 14, from completely closed (FIG. 7a) to completely exposed or open (FIG. 7d). In this manner, the user of duct 1 can manipulate the air pressure within duct 1 and of the air streams exiting orifices 5, from 100% pressure in FIG. 7a, to 75% pressure in FIG. 7b, 50% pressure in FIG. 7c, and 25% pressure in FIG. 7d. Shutter 14 can also move to any position within the range of total to zero coverage of housing apertures 12, or any subranges therebetween. This provides significant flexibility to the user of duct 1 when adjusting for different food products, cook times, and air pressure.

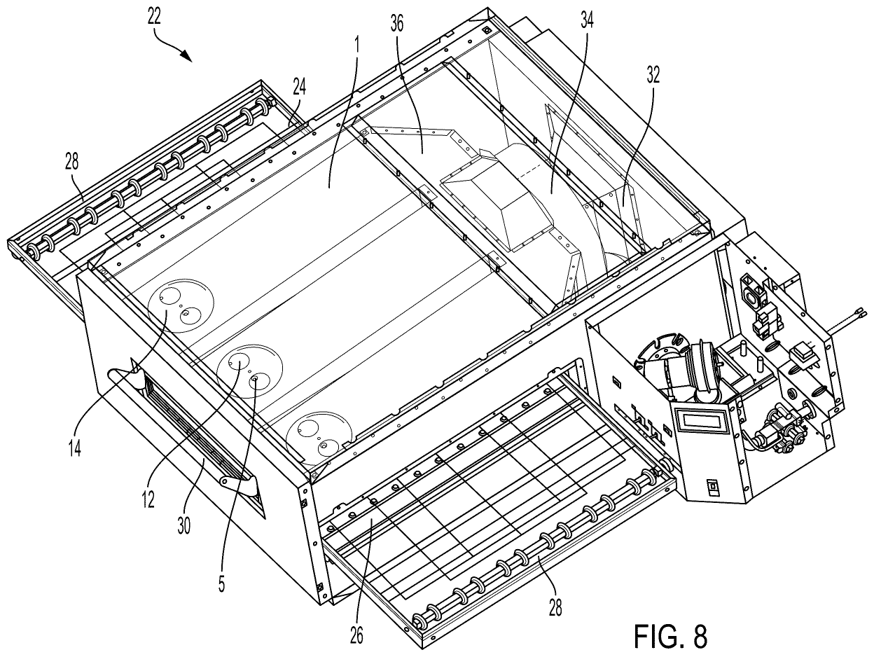

Referring to FIGS. 8-10, oven 22 is shown. Oven 22 has an entrance opening 24 and exit opening 26. Conveyor 28 extends through openings 24 and 26 and conveys a food product from entrance opening 24 to exit opening 26. Oven 22 has door 30 to allow interior access. Oven 22 has one or more ducts 1 therein, located above and/or below conveyor 28. The present embodiment shows three ducts 1 above and three ducts 1 below conveyor 28. A rear cavity chamber 32 is heated depending on the model, either by burner if gas or heating elements if electric. A fan 34 within the plenum 36 pulls hot air from the heated rear cavity chamber. This heated air circulates in plenum 36 and into opening 6 of duct 1, and then out through orifices 5 in the manner previously described. Each of ducts 1 can have the air pressure and flow therein adjusted by shutter 14.

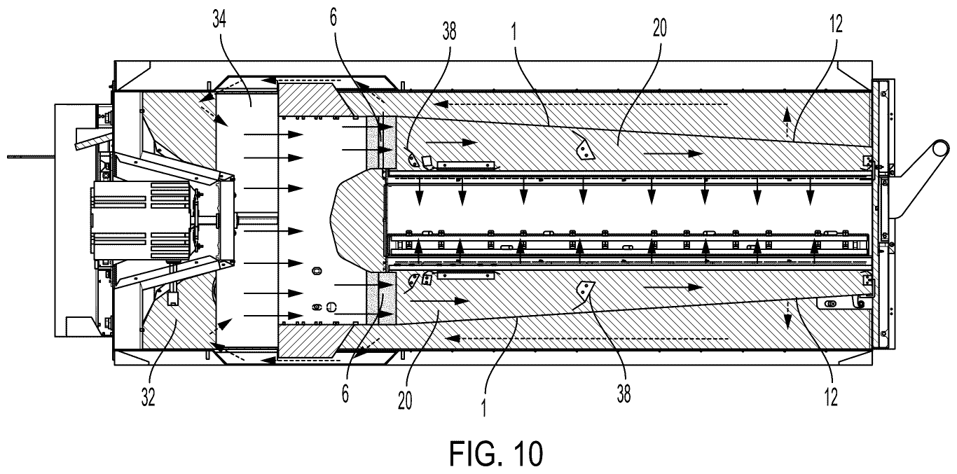

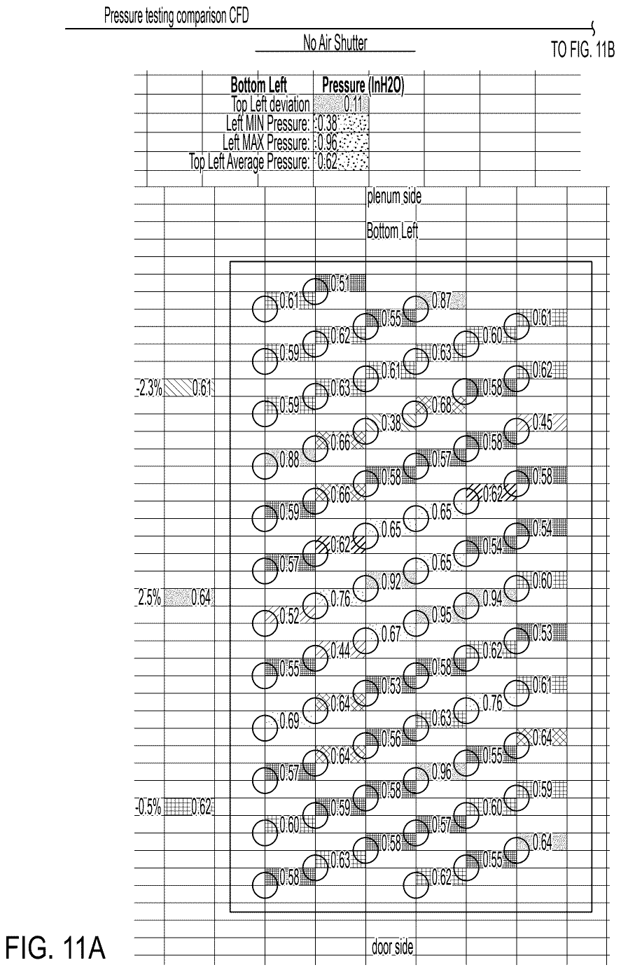

Referring specifically to FIG. 10, a theoretical flow diagram of the air within oven 20 is shown. Again, air enters duct 1 through opening 6 and toward conveyor 24 through orifices 5. Some air will also leave duct 1 through housing apertures 12. While some of this latter air may be lost into dead spaces at the top and bottom of oven 22, much of it will circulate back to chamber 32, as indicated by the arrows in FIG. 10. FIG. 10 also shows that interior space 20 of duct 1 can have one or more deflectors 38 therein. Deflectors 38 are shaped or bent pieces of metal that can be placed at strategic points within interior space 20 to guide the airflow therein.

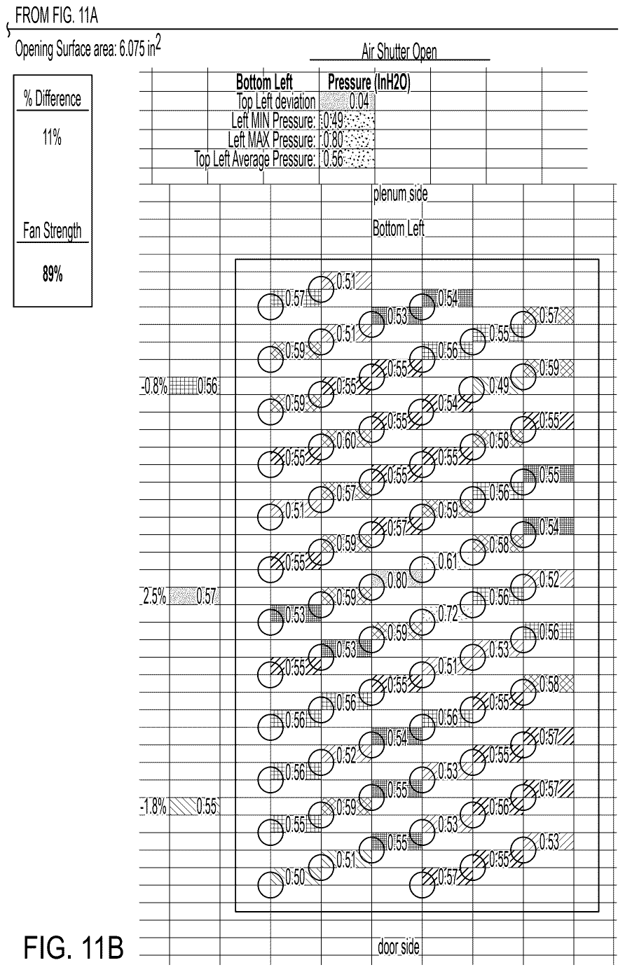

Referring to FIGS. 11A-14B, simulated air pressure data is shown for duct 1. These plots show the air pressure, in inches of water, at varying points along duct 1, from plenum end 8 to door end 10. The data in each of FIGS. 11A, 12A, 13A, and 14A is the same and represents a duct with no adjustable aperture or shutter. All data points in FIGS. 11A-14B are rounded to the nearest hundredth for display purposes. Deviation from the average pressure across the duct is also shown for the area around plenum end 8, a middle portion of duct 1, and the area around door end 10. In the duct with no aperture or shutter (i.e., the left duct in FIGS. 11A, 12A, 13A, and 14A), the mean pressure across the duct was 0.62 inches of water. The average pressure at a plenum side was 0.61 inches of water, which represented a −2.3% deviation from the mean. The average pressure in the middle was 0.64 inches of water, a +2.5% deviation from the mean. The average pressure at a door side was 0.62 inches of water, a −0.5% deviation from the mean. Ideally, the deviation from the mean pressure would be +/−5% or less, though larger deviations may be acceptable.

The data in each of FIGS. 11B, 12B, 13B, and 14B represent pressure values for duct 1 of the present disclosure, with adjustable housing apertures 12. In FIG. 11B, the housing apertures 12 were opened to a point where the exposed area was 6.075 square inches. The mean pressure across the entire duct 1 at this amount of housing aperture 12 exposure was 0.56 inches of water. The average pressure at plenum end 8 of duct 1 was 0.56 inches of water, a deviation of −0.8%. The average pressure in the middle of duct 1 was 0.57 inches of water, a deviation from the mean of +2.5%. The average pressure at door end 10 of duct 1 was 0.55 inches of water, a deviation from the mean of −1.8%.

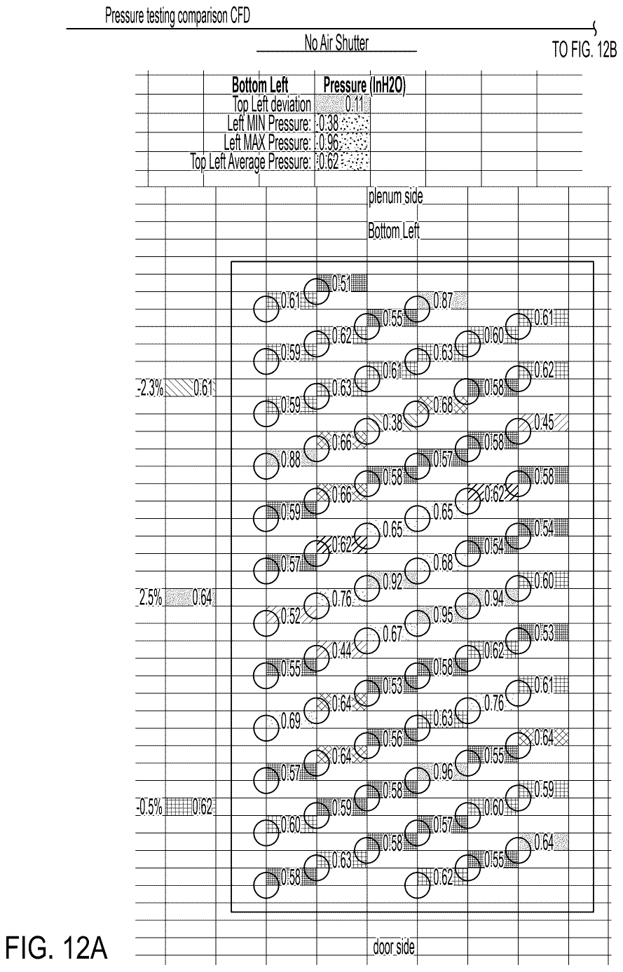

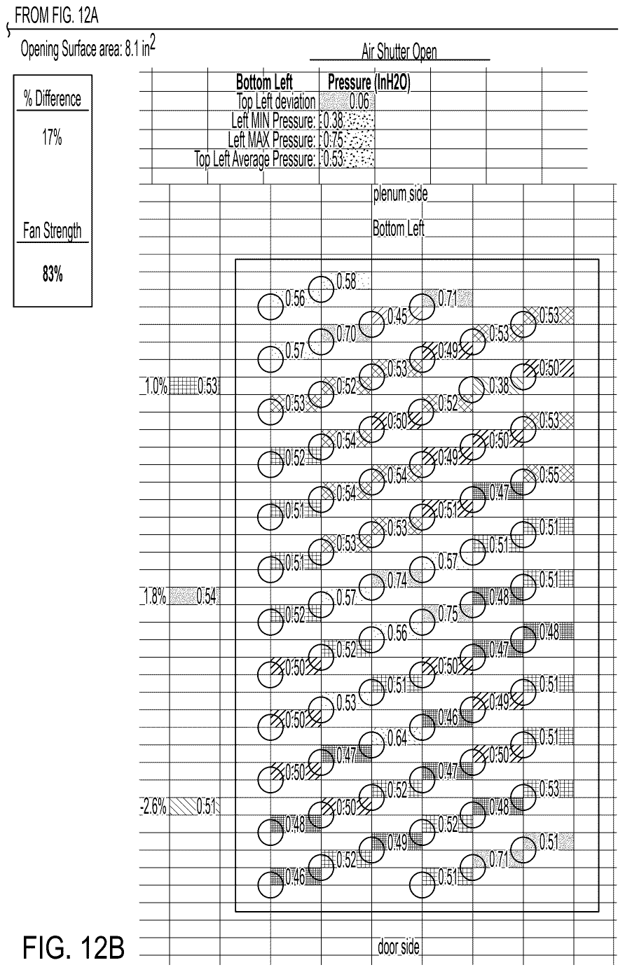

FIGS. 11A-14B thus shows one significant advantage of duct 1 of the present disclosure. As expected, when housing apertures 12 are opened, the pressure within duct 1 is reduced, both in average value and the range of pressure values. However, despite this overall drop, the pressures are still within a desired level of consistency across duct 1. FIGS. 12B, 13B, and 14B show results for housing aperture 12 exposure areas of 8.1 square inches, 12.15 square inches, and 16.2 square inches, respectively. It can be seen that as the exposed area of housing apertures 12 increases (i.e., when the amount of coverage that shutter 14 provides decreases), the deviation of pressure values increases. However, even when housing apertures 12 are opened to as much as 16.2 square inches, producing a 45% drop in average pressure across duct 1, the local deviations in pressure are still within +/−10.0%.

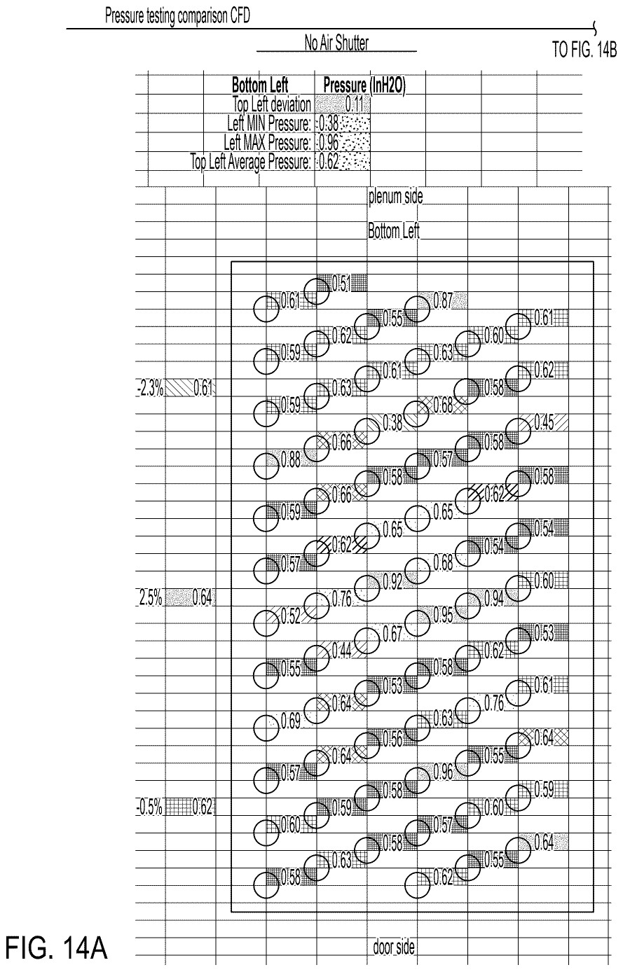

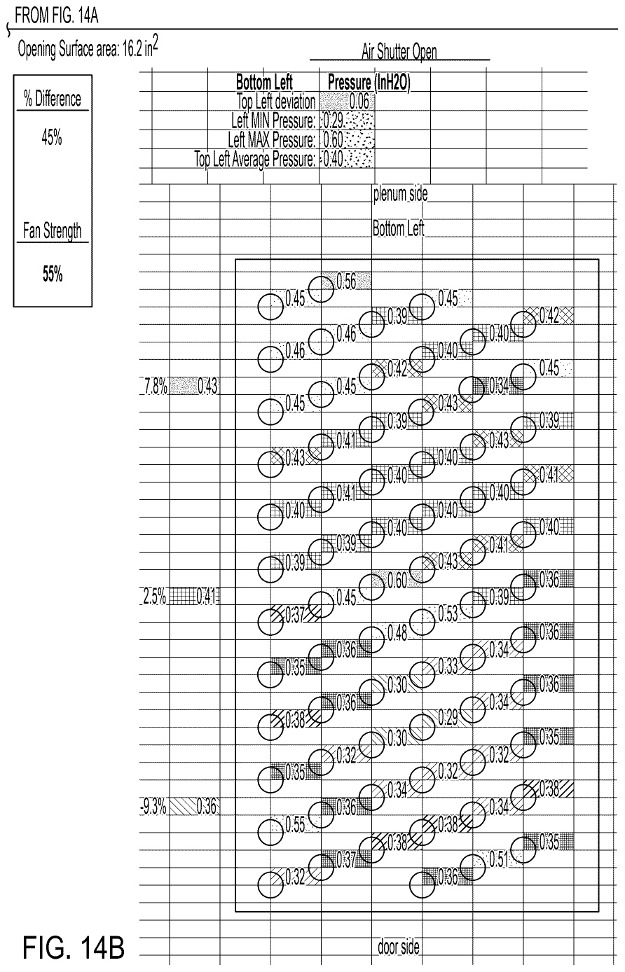

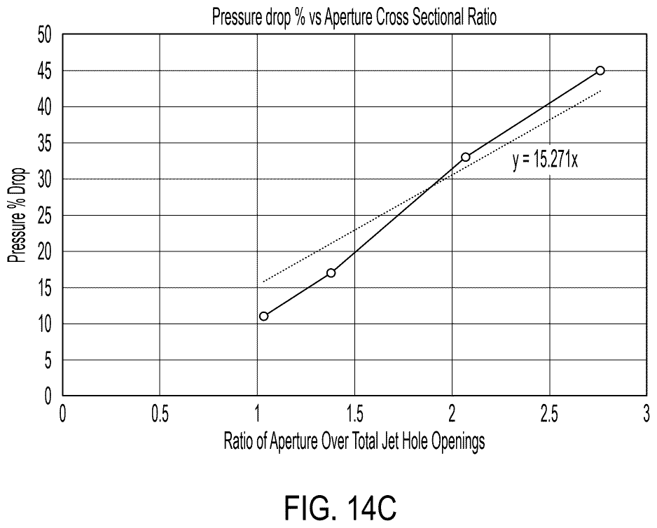

Table 1 below and FIG. 14C illustrate some of the data in FIGS. 11A-14B in graphical form. Table 1 shows the sizes of the housing apertures 12 in FIGS. 11A-14B, and the percentage difference in average air pressure in duct 1 when compared to a duct with no housing apertures 12. The ratio in the fourth column of Table 1 represents the amount of exposure of housing aperture 12, in square inches, to the size of the orifices 5 (in the present example, recited in the first column) in jet plate 4. FIG. 14C shows this data graphically, where the x-axis is the ratio in column four, and the y-axis is the percent difference in air pressure in column three. In one embodiment, the ratio of the exposed area of housing apertures 12 to the area of orifice 5 can be from one to three, or any subranges therebetween.

TABLE 1

| size of jet hole | size of | percent | |
|---|---|---|---|
| opening(in²) | aperture(in²) | diff | ratio: |
| 5.86584 | 6.075 | 11 | 1.035657 |
| | 8.1 | 17 | 1.380876 |
| | 12.15 | 33 | 2.071315 |
| | 16.2 | 45 | 2.761753 |

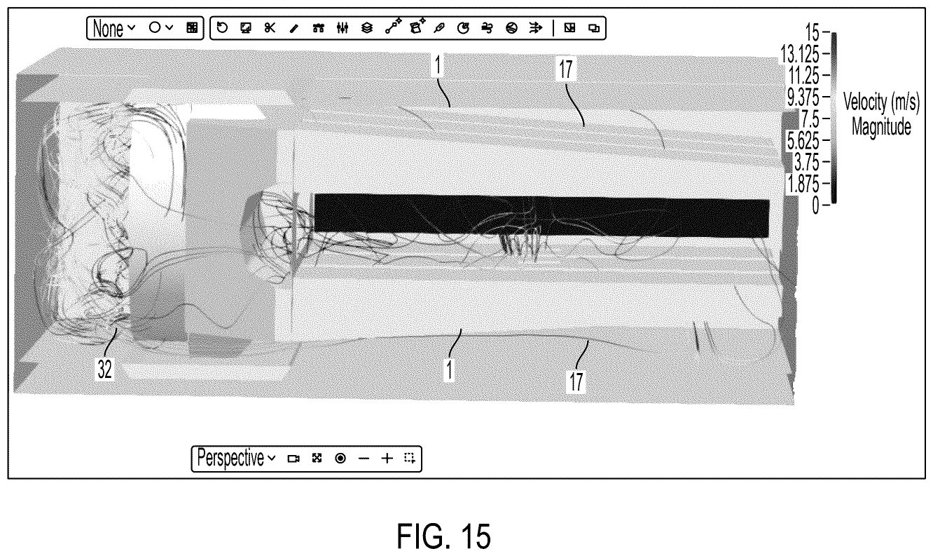

FIG. 15 shows a visual representation of airflow within an oven using duct 1. It is meant to illustrate that in the CFD test of FIGS. 11A-14B, air leaving the housing aperture 12 follows the air return pathway and recycles the air to chamber 32. This can be seen by the air flow lines that come out of the top (base 17) of duct 1 that is above the conveyor, and out of the bottom (base 17) of the duct 1 that is below the conveyor.

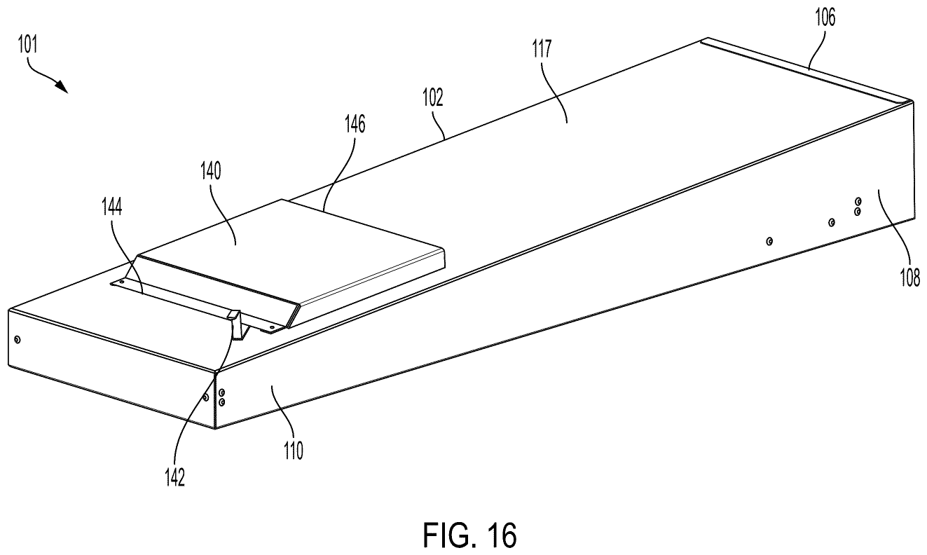

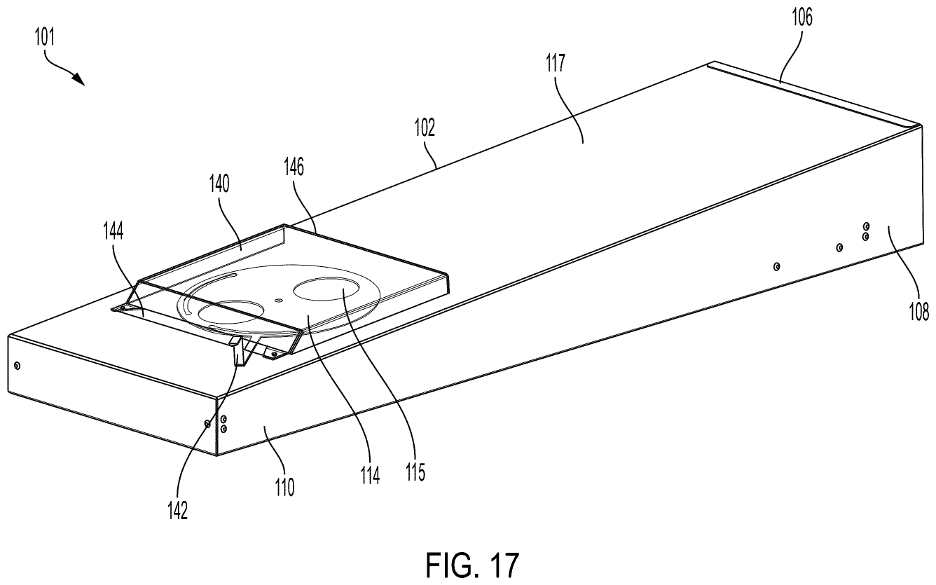

Referring to FIGS. 16-20, a second embodiment of the duct of the present disclosure is shown, namely air impingement duct 101. Duct 101 is similar in operation to duct 1, and has similarly named parts, such as housing 102, jet plate 104, and an opening 106. Duct 101 also has a back or plenum end 108 (where opening 106 is located), and a front or door end 110. Duct 101 can be used in oven 122, which is otherwise the same as oven 22, and has entrance opening 124 and exit opening 126. Conveyor 128 extends through openings 124 and 126 and conveys a food product from entrance opening 124 to exit opening 126. Oven 122 has door 130 to allow interior access.

In duct 101, shutter 114 (with shutter apertures 115 therein) selectively exposes and covers housing apertures 112, which are in base 117 of housing 102. Duct 101 differs from duct 1 in that it has aperture cover 140 and handle 142. Cover 140 is connected to base 117 of housing 102 so that it covers shutter 114 and housing apertures 112. Handle 142 is either connected to or is a unitary component of shutter 114. By manipulating or moving handle 142, a user move shutter 114 to selectively cover and uncover housing apertures 112 to the desired amount. This provides an easily accessible way for an operator to move shutter 114.

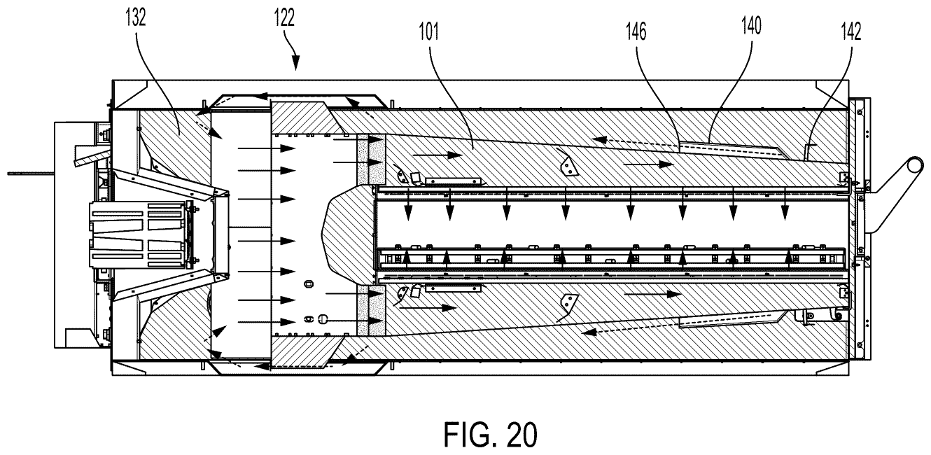

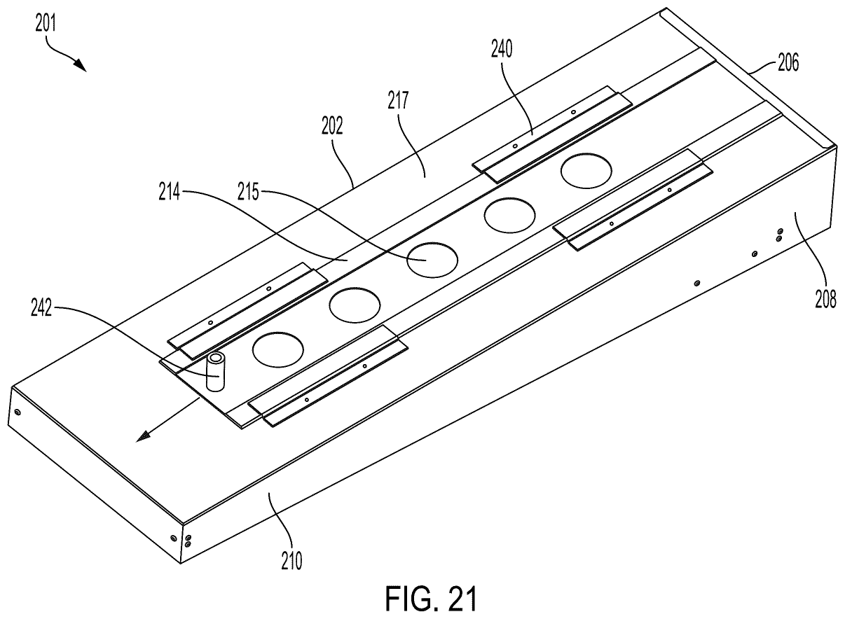

Cover 140 has a handle opening 144 at an end thereof that is close to door end 110. Handle 142 connects to shutter 114 through opening 114, and slides back and forth within opening 114. Cover 140 also has a vent opening 146 at an end thereof closer to plenum end 108 of duct 1. Referring specifically to FIG. 20, cover 140 and vent opening 146 are advantageous in that they direct air exiting housing apertures 112 back toward chamber 132. As previously discussed, this is desirable in that it mitigates the loss of heated air and recycles the heated back into the air circulation flow between chamber 132 and duct 101.

Referring to FIGS. 21-26, a third embodiment of the duct of the present disclosure is shown, namely air impingement duct 201. Duct 201 is similar in operation to ducts 1 and 101, and has similarly named parts, such as housing 202, jet plate 204, and an opening 206. Duct 201 also has a back or plenum end 208 (where opening 206 is located), and a front or door end 210. Duct 201 can be used in oven 222, which is otherwise the same as ovens 22 and 122, and has entrance opening 224 and exit opening 226. Conveyor 228 extends through openings 224 and 226 and conveys a food product from entrance opening 224 to exit opening 226. Oven 222 has door 230 to allow interior access.

Duct 201 has shutter 214, which is a plate having multiple shutter apertures 215 therein. In the shown embodiment, there are five housing apertures 212 in housing 202 and five matching shutter apertures 215 that align with housing apertures 212 in the fully exposed position. The present disclosure contemplates that there are one or more or a plurality of housing apertures 212 and shutter apertures 215. Shutter 214 has a long rectangular shape whose longitudinal axis is parallel to the longitudinal axis of base 217 of housing 202. Shutter 214 can have a length along its longitudinal axis that is from 50% to 80% the length of base 217 of housing 202, or any subranges therebetween.

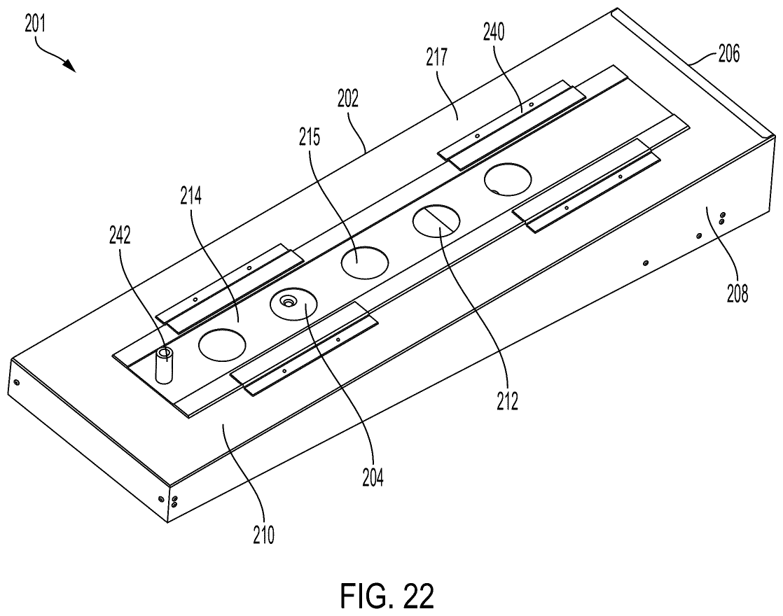

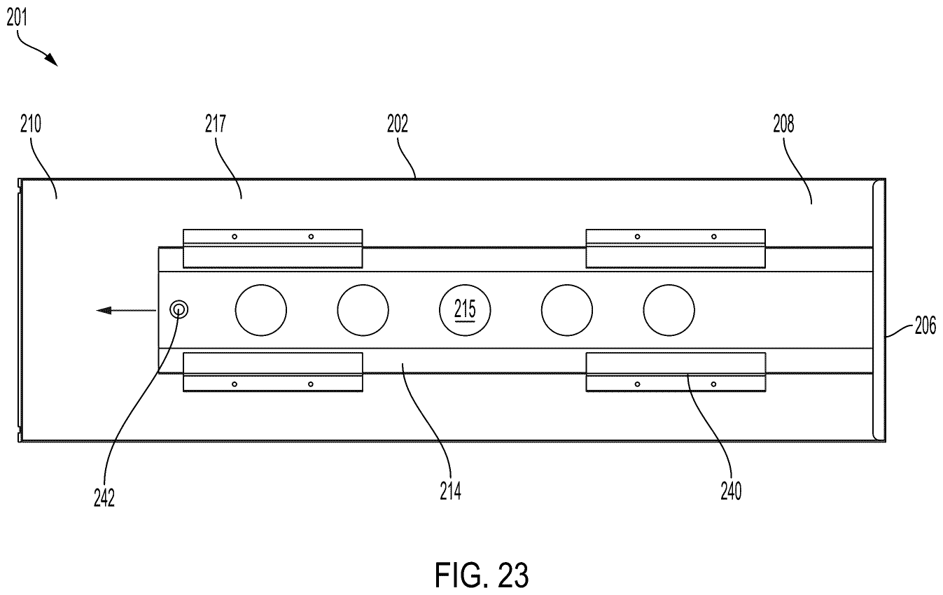

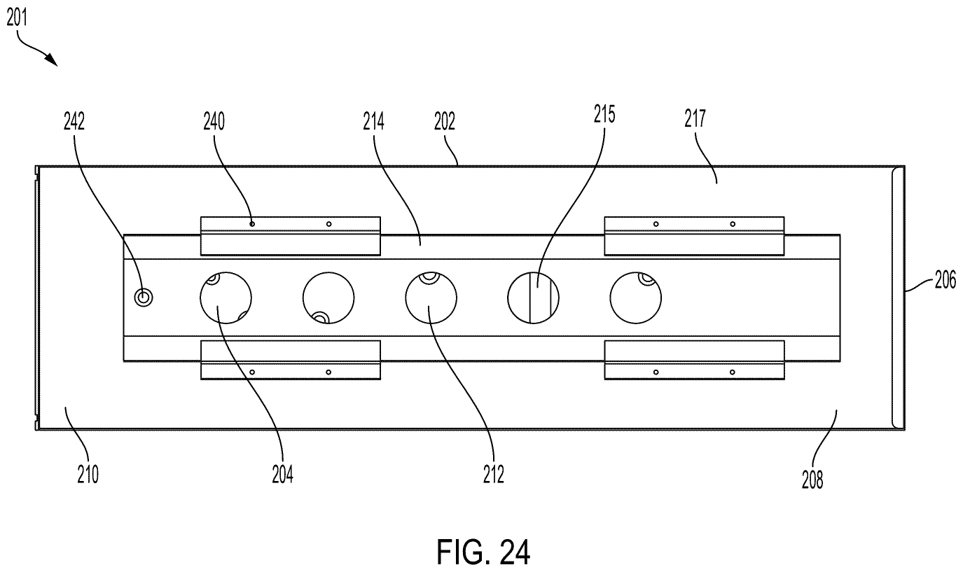

Shutter 214 is held to base 217 of housing 202 by brackets 240, which are in turn connected to or fastened to base 217. Brackets 240 allow for movement of shutter 214 with respect to base 217 and housing 202 in the longitudinal direction. A user can easily move shutter 214 with handle 242, which is a projection from and is connected to shutter 214. The user can move shutter 214 from a first position in which shutter 214 completely covers housing apertures 212 (FIGS. 21 and 23) to a second position in which housing apertures 212 are completely exposed, i.e., not covered by shutter 214 at all (FIGS. 22 and 24). Shutter 214 can also be adjusted for any desired amount of coverage of housing apertures 212, from 0% to 100%, or any subranges therebetween.

Accordingly, duct 201 and shutter 214 provide a significant amount of flexibility in adjusting the level of pressure within duct 1. The multiple housing apertures 212 that span the length of side 217 allow for the control of the pressure within duct 1 at several points between plenum end 208 and door end 210, as opposed to ducts 1 and 101, where apertures 12 and 112 are closer to door ends 10 and 110, respectively. Further, with a greater number of housing apertures 212, a greater pressure drop overall in duct 202 can be achieved than in prior embodiments.

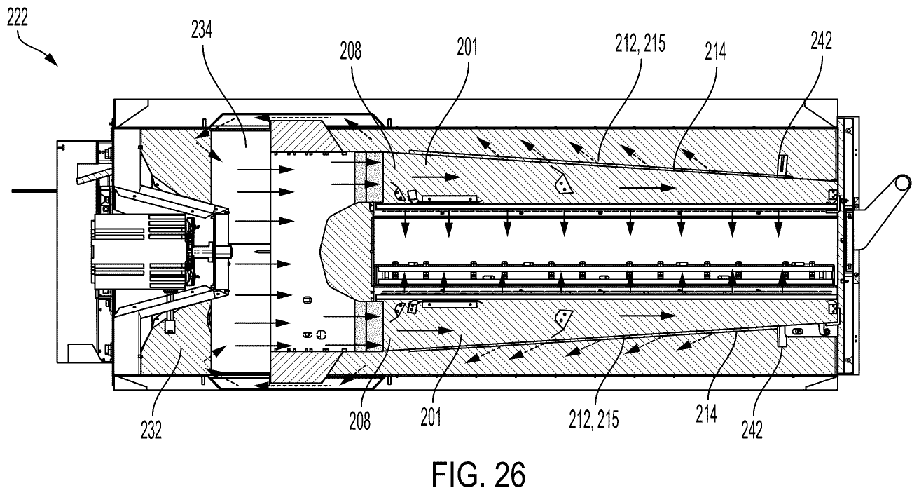

As can be seen in FIG. 26, one further advantage of duct 202 is that having multiple housing apertures 212 along the length of base 217 of housing 202 means that the air exits housing apertures 212 more slowly than in embodiments with fewer apertures. Combined with the fact that housing apertures 212 are closer to plenum end 208 than in other embodiments, this means that air exiting duct 202 may be more likely to circle back to chamber 232.

Standard duct sizes, as measured from the end of the plenum end to the end of the door end, are sixteen inches and thirty-four inches. The advantageous effects of the present disclosure have been observed in both sizes, and this applies for ducts 1, 101, and 201. The length of ducts 1, 101, and 201 can also be any subrange between sixteen and thirty-four inches, or any other suitable size. The features of the present disclosure can also be used in ducts that are shorter than sixteen inches or longer than thirty-four inches.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure is not limited to the particular embodiment(s) disclosed as the best mode contemplated, but that the disclosure will include all embodiments falling within the scope of the appended claims.

What is claimed is:

1. An air impingement duct, comprising:
a jet plate having a plurality of orifices thereon;
a housing, wherein the jet plate is connected to the housing, so that an interior space is defined by the housing and the jet plate;
a housing aperture in a base of the housing, wherein the base is opposite the jet plate; and
a shutter that is movably connected to the base, wherein movement of the shutter selectively covers and uncovers at least a portion of the housing aperture.

2. The duct of claim 1, wherein the housing has a u-shaped cross section and three sides, wherein the three sides are the base and two side walls, wherein each of the two side walls are connected to the base, wherein each of the side walls project away from the base, and each of the side walls are connected to the jet plate.

3. The duct of claim 1, wherein the shutter has a shutter aperture thereon, wherein the shutter aperture is the same size as the housing aperture.

4. The duct of claim 3, wherein the shutter is movable from a first position where the shutter aperture fully aligns with the housing aperture and the housing aperture is completely exposed, to a second position where the shutter completely covers the housing aperture.

5. The duct of claim 3, wherein the shutter is movable to a position where the shutter aperture at least partially overlaps with the housing aperture.

6. The duct of claim 3, wherein the shutter is movable to a position where the shutter covers the housing aperture by an amount that is greater than 0% and less than 100% of the area of the aperture.

7. The duct of claim 1, further comprises a cover that is connected to the housing, wherein the cover covers the shutter.

8. The duct of claim 7, wherein the cover has an opening at one end.

9. The duct of claim 1, wherein the shutter has a handle connected thereto.

10. The duct of claim 1, further comprising:
a cover that is connected to the housing, wherein the cover covers the shutter, and wherein the cover has an opening at one end; and
a handle connected to the shutter, so that the shutter is moveable via the handle.

11. The duct of claim 10, wherein the cover has a second opening at a second end, and the handle is connected to the shutter through the second opening.

12. The duct of claim 1, wherein the shutter has a circular shape.

13. The duct of claim 1, wherein the shutter has a rectangular shape and a first longitudinal axis, and the housing has a second longitudinal axis, wherein the first longitudinal axis is parallel to the second longitudinal axis, and the shutter moves with respect to the housing along the first and second longitudinal axes.

14. The duct of claim 13, further comprising a bracket connected to the housing, wherein the bracket partially covers the shutter, and the shutter moves with respect to the housing within the bracket.

15. The duct of claim 13, wherein the housing has a plurality of housing apertures therein, and the shutter has a plurality of shutter apertures therein, and wherein each of the housing apertures aligns with a corresponding one of the shutter apertures.

16. The duct of claim 1, wherein the housing has a plurality of housing apertures therein, and the shutter has a plurality of shutter apertures therein, and wherein each of the housing apertures aligns with a corresponding one of the shutter apertures.

17. A conveyor oven, comprising:
an oven housing;
a conveyor;
an entrance and an exit, wherein the conveyor passes through the entrance, exit, and oven housing, to convey a food product therethrough;
a plenum within the housing, wherein heated air is circulated within the plenum; and
the duct of claim 1, wherein the duct 1 is above or below the conveyor,
wherein the heated air passes from the plenum into the duct of claim 1, and out of the duct of claim 1 onto the food product.

18. The oven of claim 17, comprising a duct of claim 1 above the conveyor, and a second duct of claim 1 below the conveyor.

19. The oven of claim 17, further comprising a heater and a fan in communication with the plenum, wherein the heater heats ambient air to form the heated air, and wherein the fan moves the heated air into the plenum.

20. A method of operating a conveyor oven, wherein the conveyor oven comprises:
an oven housing;
a conveyor, wherein the conveyor passes through the oven housing, to convey a food product therethrough;
a plenum within the housing; and
the duct of claim 1, the method comprising the steps of:
passing heated air from the plenum into the duct and out of the duct onto the food product; and
adjusting the shutter to adjust a pressure of the heated air within the duct.

21. The method of claim 20, wherein the duct has an average air pressure therein, and the air pressure at any point within the duct is within 10% or less of the average pressure throughout the entire duct.
